(19) United States
(12) Patent Application Publication
(10) Pub. No.: US 2023/0198686 A1
(43) Pub. Date: Jun. 22, 2023

(54) WIRELESS COMMUNICATION METHOD AND USER EQUIPMENT

(71) Applicant: OROPE FRANCE SARL, Neuilly-sur-Seine (FR)

(72) Inventor: Hao LIN, Neuilly-sur-Seine (FR)

(21) Appl. No.: 18/109,429

(22) Filed: Feb. 14, 2023

Related U.S. Application Data
(63) Continuation of application No. PCT/IB2021/057804, filed on Aug. 26, 2021.

(30) Foreign Application Priority Data
Aug. 28, 2020 (WO) PCT/IB2020/000806

(51) Int. Cl. H04L 1/1867; H04W 72/232

(52) U.S. Cl. CPC H04L 1/1867; H04W 72/232

(57) ABSTRACT

A wireless communication method applied in a User Equipment (UE) includes: detecting a first Downlink Control Information (DCI) format; receiving a first Physical Downlink Shared CHannel (PDSCH) scheduled by the first DCI format; detecting a second DCI format, the second DCI format being detected after the first DCI format; receiving a second PDSCH, the second PDSCH being received after the first PDSCH; and transmitting Hybrid Automatic Repeat request-ACKnowledgement (HARQ-ACK) information corresponding to the first PDSCH in a Physical Uplink Control CHannel (PUCCH) or a Physical Uplink Shared CHannel (PUSCH) in a first slot indicated by the second DCI format.

### CROSS-REFERENCE TO RELATED APPLICATIONS

This application is a continuation of International Application No. PCT/IB2021/057804, filed Aug. 26, 2021, which claims the benefit of priority to International Application No. PCT/IB2020/000806, filed Aug. 28, 2020, both of which are hereby incorporated by reference in their entireties.

### TECHNICAL FIELD

The present disclosure relates to communication technology, and more particularly, to a wireless communication method and the associated User Equipment (UE).

### BACKGROUND

In an unlicensed band, an unlicensed spectrum is a shared spectrum that may be used for communication in a wireless communication network. Communication devices in different communication systems can use the unlicensed spectrum as long as the unlicensed spectrum meets regulatory requirements set by a country or a region on the spectrum, and do not need to apply for a proprietary spectrum authorization from a government.

In order to allow various communication systems that use an unlicensed spectrum for wireless communication to coexist friendly in the spectrum, some countries or regions specify regulatory requirements that must be met to use the unlicensed spectrum. For example, a communication device follows a principle of “Listen Before Talk (LBT)”. As a channel access scheme, LBT lies in that the communication device needs to perform channel sensing before transmitting a signal on a channel. Only when an outcome of the LBT shows that the channel is idle, the communication device can perform signal transmission; otherwise, the communication device cannot perform signal transmission. In order to ensure fairness, once a device successfully occupies a channel, a transmission duration cannot exceed the Maximum Channel Occupancy Time (MCOT).

According to the related art, a method of UE multiplexing a HARQ-ACK in PUCCH or PUSCH applies as follows:

If a UE receives a first PDSCH scheduled by a first DCI format that the UE detects in a first PDCCH monitoring occasion and includes a PDSCH-to-HARQ_feedback timing indicator field providing an inapplicable value from dlDataToUL-ACK,
if the UE detects a second DCI format, the UE multiplexes the corresponding HARQ-ACK information in a PUCCH or PUSCH transmission in a slot that is indicated by a value of a PDSCH-to-HARQ_feedback timing indicator field in the second DCI format, where
   if the UE is not provided pdsch-HARQ-ACK-Codebook = enhancedDynamic-r16, the UE detects the second DCI format in any PDCCH monitoring occasion after the first one
   if the UE is provided pdsch-HARQ-ACK-Codebook = enhancedDynamic-r16, the UE detects the second DCI format in any PDCCH monitoring occasion after the first one, and the second DCI format indicates a HARQACK information report for a same PDSCH group index as indicated by the first DCI format as described in Clause 9.1.3.3
   if the UE is provided pdsch-HARQ-ACK-OneShotFeedback-r16, the UE detects the second DCI format in any PDCCH monitoring occasion after the first one, and the second DCI format includes a One-shot HARQACK request field with value 1, the UE includes the HARQ-ACK information in a Type-3 HARQ-ACK codebook, as described in Clause 9.1.4.
otherwise, the UE does not multiplex the corresponding HARQ-ACK information in a PUCCH or PUSCH transmission.

The otherwise condition is not clear, and the UE does not know when to enter the otherwise condition.

### SUMMARY

An object of the present disclosure is to propose a wireless communication method and the associated user equipment (UE), which can solve issues in the related art.

It is an object of the present disclosure to provide a wireless communication method and the associated UE, capable of solving or mitigating the above problem.

According to a first aspect of the present disclosure, a wireless communication method applied in a UE is provided. The wireless communication method includes: detecting a first Downlink Control Information (DCI) format; receiving a first Physical Downlink Shared CHannel (PDSCH) scheduled by the first DCI format; detecting a second DCI format, the second DCI format being detected after the first DCI format; receiving a second PDSCH, the second PDSCH being received after the first PDSCH; and transmitting Hybrid Automatic Repeat request-ACKnowledgement (HARQ-ACK) information corresponding to the first PDSCH in a Physical Uplink Control CHannel (PUCCH) or a Physical Uplink Shared CHannel (PUSCH) in a first slot indicated by the second DCI format.

According to a second aspect of the present disclosure, a UE is provided. The UE includes: a memory having computer program stored thereon; and a processor configured to invoke and run the computer program whereby the UE is operative to perform the method according to the above first aspect.

According to a third aspect of the present disclosure, a chip is provided. The chip includes a processor configured to invoke and run a computer program from a memory whereby an apparatus provided with the chip is operative to perform the method according to the above first aspect.

According to a fourth aspect of the present disclosure, a computer readable storage medium is provided. The computer readable storage medium has a computer program stored thereon, and the computer program, when executed by a computer, causes the computer to perform the method according to the above first aspect.

According to a fifth aspect of the present disclosure, a computer program product is provided. The computer program product includes computer program instructions, and the computer program instructions, when executed by a computer, cause the computer to perform the method according to the above first aspect.

According to a sixth aspect of the present disclosure, a computer program is provided. The computer program, when executed by a computer, causes the computer to perform the method according to the above first aspect.

### BRIEF DESCRIPTION OF THE DRAWINGS

The above and other objects, features and advantages will be more apparent from the following description of embodiments with reference to the figures, in which:

FIG. 1 is a flowchart illustrating a wireless communication method 100 applied in a UE according to embodiments of the present disclosure;

FIG. 2 is a block diagram of a UE 200 according to embodiments of the present disclosure;

FIG. 3 is a block diagram of a communication device 300 according to embodiments of the present disclosure;

FIG. 4 is a block diagram of an apparatus 400 according to embodiments of the present disclosure; and

FIG. 5 is a block diagram of a communication system 500 according to embodiments of the present disclosure.

### DETAILED DESCRIPTION

Hereinafter, the present disclosure will be described with reference to embodiments shown in the attached drawings. However, it is to be understood that those descriptions are just provided for illustrative purpose, rather than limiting the present disclosure. Further, in the following, descriptions of known structures and techniques are omitted so as not to unnecessarily obscure the concept of the present disclosure.

As used herein, the term “wireless communication network” refers to a network following any suitable communication standards, such as NR, LTE-Advanced (LTE-A), LTE, Wideband Code Division Multiple Access (WCDMA), High-Speed Packet Access (HSPA), and so on. Furthermore, the communications between a terminal device such as a User Equipment (UE) and a network device in the wireless communication network may be performed according to any suitable generation communication protocols, including, but not limited to, Global System for Mobile Communications (GSM), Universal Mobile Telecommunications System (UMTS), Long Term Evolution (LTE), and/or other suitable 1G (the first generation), 2G (the second generation), 2.5G, 2.75G, 3G (the third generation), 4G (the fourth generation), 4.5G, 5G (the fifth generation) communication protocols, wireless local area network (WLAN) standards, such as the IEEE 802.11 standards; and/or any other appropriate wireless communication standard, such as the Worldwide Interoperability for Microwave Access (WiMax), Bluetooth, and/or ZigBee standards, and/or any other protocols either currently known or to be developed in the future.

The term “network device” refers to a device in a wireless communication network via which a UE accesses the network and receives services therefrom. The network device refers to a base station (BS), an access point (AP), or any other suitable device in the wireless communication network. The BS may be, for example, a node B (NodeB or NB), an evolved NodeB (eNodeB or eNB), or a (next) generation (gNB), a Remote Radio Unit (RRU), a radio header (RH), a remote radio head (RRH), a relay, a low power node such as a femto, a pico, and so forth. Yet further examples of the network device may include multi-standard radio (MSR) radio equipment such as MSR BSs, network controllers such as radio network controllers (RNCs) or base station controllers (BSCs), base transceiver stations (BTSs), transmission points, transmission nodes. More generally, however, the network device may represent any suitable device (or group of devices) capable, configured, arranged, and/or operable to enable and/or provide a UE access to the wireless communication network or to provide some service to a UE that has accessed the wireless communication network.

The term “UE” refers to any end device that can access a wireless communication network and receive services therefrom. By way of example and not limitation, the UE may be, for example, a Subscriber Station (SS), a Portable Subscriber Station, a Mobile Station (MS), or an Access Terminal (AT). The UE may include, but not limited to, portable computers, desktop computers, image capture terminal devices such as digital cameras, gaming terminal devices, music storage and playback appliances, a mobile phone, a cellular phone, a smart phone, voice over IP (VoIP) phones, wireless local loop phones, tablets, personal digital assistants (PDAs), wearable terminal devices, vehicle-mounted wireless terminal devices, wireless endpoints, mobile stations, laptop-embedded equipment (LEE), laptop-mounted equipment (LME), USB dongles, smart devices, wireless customer-premises equipment (CPE) and the like. As used herein, a “UE” may not necessarily have a “user” in the sense of a human user who owns and/or operates the relevant device. Instead, a UE may represent a device that is intended for sale to, or operation by, a human user but that may not initially be associated with a specific human user.

As used herein, a downlink (DL) transmission refers to a transmission from a network device to a UE, and an uplink (UL) transmission refers to a transmission in an opposite direction.

References in the specification to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the associated listed terms. The terminology used herein is for the purpose of describing particular embodiments only and is not intended to be liming of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/ or combinations thereof.

In the following description and claims, unless defined otherwise, all technical and scientific terms used herein have the same meaning as commonly understood by one of ordinary skills in the art to which this disclosure belongs.

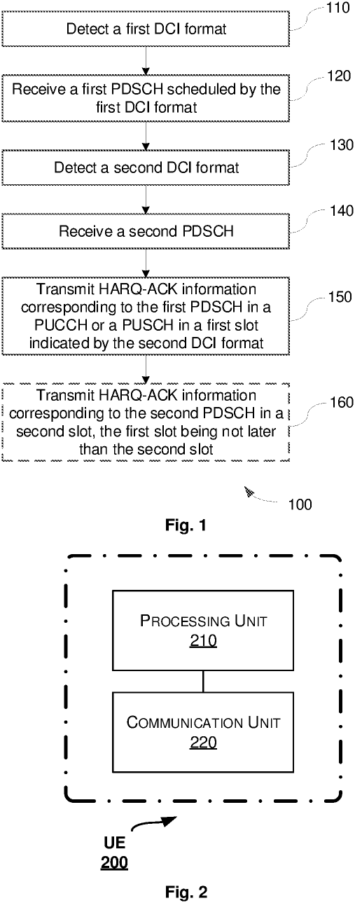

FIG. 1 is a flowchart illustrating a wireless communication method 100 according to embodiments of the present disclosure. The wireless communication method 100 can be performed at the UE.

At block 110, the UE detects a first Downlink Control Information (DCI) format.

At block 120, the UE receives a first Physical Downlink Shared CHannel (PDSCH) scheduled by the first DCI format. For example, the UE may receive the first PDSCH from a network device such as a base station.

At block 130, the UE detects a second DCI format. The second DCI format is detected after the first DCI format.

At block 140, the UE receives a second PDSCH. The second PDSCH is received after the first PDSCH. For example, the UE may receive the second PDSCH from the network device.

As an example, the second PDSCH may be a Semi-Persistent Scheduling (SPS) PDSCH. As another example, the second PDSCH may be configured by a higher layer.

At block 150, the UE transmits Hybrid Automatic Repeat request-ACKnowledgement (HARQ-ACK) information corresponding to the first PDSCH in a Physical Uplink Control CHannel (PUCCH) or a Physical Uplink Shared CHannel (PUSCH) in a first slot indicated by the second DCI format. For example, the PUCCH or the PUSCH may be assigned by the second DCI format. For example, the UE may transmit the HARQ-ACK information corresponding to the first PDSCH to the network device.

In an embodiment, the first DCI format may include a PDSCH-to-HARQ_feedback timing indicator field providing an inapplicable value.

In an embodiment, the wireless communication method 100 may further include a step as illustrated by block 160. At block 160, the UE transmits HARQ-ACK information corresponding to the second PDSCH in a second slot. In this embodiment, the first slot is not later than the second slot. For example, the UE may transmit the HARQ-ACK information corresponding to the second PDSCH to the network device.

As an example, the second DCI format may include a PDSCH-to-HARQ_feedback timing indicator field providing a value indicating the first slot.

In an embodiment, the second DCI format may include a One-shot HARQ-ACK request field with a value of 1.

In an embodiment, the second DCI format may include a PDSCH group index field indicating a same PDSCH group index as the first PDSCH, or a feedback request for both PDSCH groups corresponding to the first DCI format and the second DCI format.

For example, when the first PDSCH belongs to PDSCH Group 0 and the PDSCH indicated by the second DCI format also belongs to PDSCH Group 0, the second DCI format indicates a HARQ-ACK information report for PDSCH Group 0. As another example, when the first PDSCH belongs to PDSCH Group 0 and the PDSCH indicated by the second DCI format belongs to PDSCH Group 1, evidently, the second DCI format shall indicate a HARQ-ACK information report for PDSCH Group 1, and optionally, may further indicate a HARQ-ACK information report for PDSCH Group 0, i.e., the same PDSCH group as indicated by the first DCI format. Therefore, the second DCI format may indicate a HARQ-ACK information report for a same PDSCH group index as indicated by the first DCI format.

In this embodiment, for example, the UE may be provided with pdsch-HARQ-ACK-Codebook=enhancedDynamic-r16.

It should be appreciated that the present disclosure is not limited to the specific sequence as illustrated in FIG. 1. As an example, the step illustrated by block 130 may also occur at the same time as or before the step illustrated by block 120. As another example, the step illustrated by block 150 may also occur at the same time as or before the step illustrated by block 140.

Hereinafter, some examples will be explained for sake of illustration.

### Example 1

If a UE receives a first PDSCH scheduled by a first DCI format that the UE detects in a first Physical Downlink Control Channel (PDCCH) monitoring occasion and includes a PDSCH-to-HARQ_feedback timing indicator field providing an inapplicable value from dlDataToUL-ACK, when the UE receives a second PDSCH (for DL SPS) after a first PDSCH, the UE transmits HARQ-ACK for the first PDSCH:
if the UE detects a second DCI format in any PDCCH monitoring occasion after the first DCI format where the second DCI format assigns an applicable K1 value for the first PDSCH (as specified in TS38.213 v16.2.0 section 9.1.3) that corresponds to HARQ-ACK timing no later than the HARQ-ACK timing assigned for the second PDSCH, or
if the UE detects a second DCI format in any PDCCH monitoring occasion after the first DCI format (as specified in TS38.213 section 9.1.4), and the second DCI format includes a One-shot HARQ-ACK request field with value 1.

Otherwise, the UE does not transmit HARQ-ACK for the first PDSCH. Optionally, the UE does not multiplex the HARQ-ACK information for the first PDSCH in a PUCCH or PUSCH transmission.

### Example 2

If a UE receives a first PDSCH scheduled by a first DCI format that the UE detects in a first PDCCH monitoring occasion and includes a PDSCH-to-HARQ_feedback timing indicator field providing an inapplicable value from dlDataToUL-ACK, when the UE receives a second PDSCH (for DL SPS) after a first PDSCH, the UE transmits HARQ-ACK for the first PDSCH:
if the UE detects a second DCI format in any PDCCH monitoring occasion after the first DCI format where the second DCI format assigns an applicable K1 value for the first PDSCH (as specified in TS38.213 v16.2.0 section 9.1.3) that corresponds to HARQ-ACK timing no later than the HARQ-ACK timing assigned for the second PDSCH, or
if the UE detects a second DCI format in any PDCCH monitoring occasion after the first DCI format (as specified in TS38.213 section 9.1.4), and the second DCI format does not schedule PDSCH and includes a One-shot HARQ-ACK request field with value 1.

Otherwise, the UE does not transmit HARQ-ACK for the first PDSCH. Optionally, the UE does not multiplex the HARQ-ACK information for the first PDSCH in a PUCCH or PUSCH transmission.

### Example 3

When a UE receives a second PDSCH (for DL SPS) after a first PDSCH, where the first PDSCH is not assigned an applicable K1 value in the corresponding first DCI format, if the UE does not detect a second DCI format in any PDCCH monitoring occasion after the first DCI format where the second DCI format assigns an applicable K1 value for the first PDSCH (as specified in TS38.213 section 9.1.3) that corresponds to HARQ-ACK timing no later than the HARQ-ACK timing assigned for the second PDSCH, then the UE multiplexes the HARQ-ACK information for the first PDSCH in the PUCCH (or PUSCH) used for reporting HARQ-ACK for the second (DL SPS) PDSCH, where the PUCCH resource is indicated by PUCCH resource indicator field in the first DCI format.

### Example 4

When a UE receives a second PDSCH (for DL SPS) after a first PDSCH, where the first PDSCH is not assigned an applicable K1 value in the corresponding first DCI format,
the UE transmits HARQ-ACK for the first PDSCH:
   if the UE detects a second DCI format in any PDCCH monitoring occasion after the first DCI format where the second DCI format assigns an applicable K1 value for the first PDSCH (as specified in TS38.213 section 9.1.3) that corresponds to HARQ-ACK timing no later than the HARQ-ACK timing assigned for the second PDSCH, or
   if the UE detects a second DCI format in any PDCCH monitoring occasion after the first DCI format (as specified in TS38.213 section 9.1.4), and the second DCI format includes a One-shot HARQ-ACK request field with value 1.
   if the UE is provided pdsch-HARQ-ACK-Codebook = enhancedDynamic-r16 and the UE detects a second DCI format in any PDCCH monitoring occasion after the first DCI format (as specified in TS38.213 section 9.1.3), and the second DCI format includes a feedback request for both PDSCH groups (q is set to 1).
Otherwise, the UE does not multiplex the HARQ-ACK information for the first PDSCH in a PUCCH or PUSCH transmission.

In some embodiments, a UE receives a first PDSCH from a base station, and receives a second PDSCH from the base station, the UE transmits HARQ-ACK information corresponding to the first PDSCH in a first PUCCH or a first PUSCH. In some embodiments, the UE transmits the HARQ-ACK information corresponding to the first PDSCH in the first PUCCH or the first PUSCH if a first condition is met. In some embodiment, the first PDSCH is scheduled by a first DCI format. In some embodiments, the first DCI includes a PDSCH-to-HARQ_feedback timing indicator field providing an inapplicable value from dlDataToUL-ACK. In some embodiments, the second PDSCH is configured by a higher layer. In some embodiments, the second PDSCH includes a SPS PDSCH. In some embodiments, the second PDSCH is received after the first PDSCH.

In some embodiments, the first condition includes at least one of the followings:
the UE detects a second DCI format in any PDCCH monitoring occasion after the first DCI format where the second DCI format includes a PDSCH-to-HARQ_feedback timing indicator field providing an applicable value from dlDataToUL-ACK for the first PDSCH (as specified in TS38.213 v16.2.0 section 9.1.3) that corresponds to HARQ-ACK timing not later than the HARQ-ACK timing assigned for the second PDSCH; or
if the UE is provided with pdsch-HARQ-ACK-Codebook=enhancedDynamic-r16 and the UE detects a second DCI format in any PDCCH monitoring occasion after the first DCI format (as specified in TS38.213 v16.2.0 section 9.1.3), and the second DCI format includes a field for a number of requested PDSCH group(s) requesting HARQ-ACK feedback from two PDSCH groups (set this field value q=1 as described in TS 38.213 v16.2.0 section 9.1.3); or
if the UE is provided with pdsch-HARQ-ACK-Codebook=enhancedDynamic-r16 and the UE detects a second DCI format in any PDCCH monitoring occasion after the first DCI format (as specified in TS38.213 v16.2.0 section 9.1.3), and the second DCI format includes a PDSCH group index field indicating a same PDSCH group index as the first PDSCH; or
the UE detects a second DCI format in any PDCCH monitoring occasion after the first DCI format (as specified in TS38.213 section 9.1.4), and the second DCI format does not schedule PDSCH and includes a One-shot HARQ-ACK request field with value 1.

In some embodiments, if the first condition is not met, the UE drops the HARQ-ACK information of the first PDSCH. In some embodiments, the UE transmits the HARQ-ACK information corresponding to the first PDSCH in a second PUCCH or the first PUSCH if a first condition is not met. In some embodiments, the first PUCCH is assigned by the second DCI format. In some embodiments, the second PUCCH or the second PUSCH includes a HARQ-ACK information corresponding to the second PDSCH. In some embodiments, the second PUCCH is assigned by the first DCI format. In some embodiments, the UE can declare a capability to the network device such as a gNB for transmitting HARQ-ACK information corresponding to the first PDSCH in the first PUCCH or PUSCH even when the first condition is not met. In some embodiments, the UE reports HARQ-ACK information=NACK corresponding to the first PDSCH in the first PUCCH or PUSCH.

In some embodiments, the UE reports HARQ-ACK information=NACK corresponding to the first PDSCH in the first PUCCH or PUSCH if the first condition is not met.

In some embodiments, the UE does not include the HARQ-ACK information corresponding to the first PDSCH in the first PUCCH or PUSCH.

In some embodiments, the UE does not include the HARQ-ACK information corresponding to the first PDSCH in the first PUCCH or PUSCH if the first condition is not met.

In some embodiments, the UE declares a capability to transmit the HARQ-ACK information corresponding to the first PDSCH in the first PUCCH or PUSCH, if the first condition is not met.

In some embodiments, the capability is relevant to a HARQ-ACK codebook type in the first PUCCH or PUSCH.

In some embodiments, the HARQ-ACK codebook type includes type 2 HARQ-ACK codebook without pdsch-HARQ-ACK-Codebook = enhancedDynamic-r16 or type 2 HARQ-ACK codebook with type 2 HARQ-ACK codebook or type 3 HARQ-ACK codebook as described in TS 38.213 V16.2.0 in section 9.1.

Correspondingly to the wireless communication method 100 as described above, a UE is provided. FIG. 2 is a block diagram of a UE 200 according to embodiments of the present disclosure.

As shown in FIG. 2, the UE 200 includes a processing unit 210 and a communication unit 220.

The processing unit 210 is configured to detect a first DCI format and a second DCT format. The second DCI format is detected after the first DCI format.

The communication unit 220 is configured to receive first PDSCH scheduled by the first DCI format and a second PDSCH. The second PDSCH is received after the first PDSCH. The communication unit 220 is further configured to transmit HARQ-ACK information corresponding to the first PDSCH in a PUCCH or a PUSCH in a first slot indicated by the second DCI format.

In an embodiment, the communication unit 220 is further configured to transmit HARQ-ACK information corresponding to the second PDSCH in a second slot. The first slot is not later than the second slot.

As an example, the second DCI format may include a PDSCH-to-HARQ_feedback timing indicator field providing a value indicating the first slot.

In an embodiment, the second DCI format may include a One-shot HARQ-ACK request field with a value of 1.

In an embodiment, the second DCI format may include a PDSCH group index field indicating a same PDSCH group index as the first PDSCH, or a feedback request for both PDSCH groups corresponding to the first DCI format and the second DCI format. In other words, the second DCI format may indicate a HARQ-ACK information report for a same PDSCH group index as indicated by the first DCI format.

In this embodiment, for example, the UE may be provided with pdsch-HARQ-ACK-Codebook=enhancedDynamic-r16.

In an embodiment, the second PDSCH may be a SPS PDSCH.

In an embodiment, the PUCCH or the PUSCH may be assigned by the second DCI format.

In an embodiment, the second PDSCH may be configured by a higher layer.

In an embodiment, the first DCI format may include a PDSCH-to-HARQ_feedback timing indicator field providing an inapplicable value.

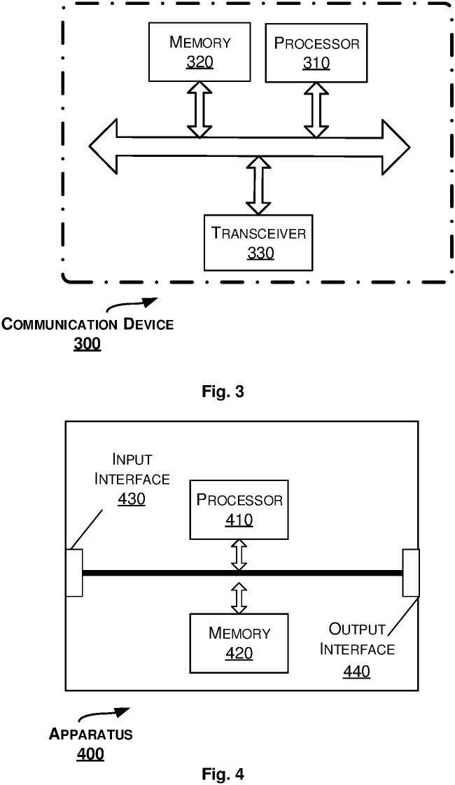

FIG. 3 is a block diagram of a communication device 300 according to embodiments of the present disclosure. The communication device 300 shown in FIG. 3 includes a processor 310, and the processor 310 can invoke and run a computer program from a memory to implement the wireless communication method 100 according to the embodiments of the present disclosure.

In an embodiment, as shown in FIG. 3, the communication device 300 may further include a memory 320. The processor 310 may revoke and run a computer program from the memory 320 to implement the wireless communication method 100 according to the embodiments of the present disclosure.

The memory 320 may be a separate device independent of the processor 310, or may be integrated in the processor 310.

In an embodiment, as shown in FIG. 3, the communication device 300 may further include a transceiver 330, and the processor 310 may control the transceiver 330 to communicate with other devices, e.g., transmitting information or data to other devices, or receiving information or data from other devices.

The transceiver 330 may include a transmitter and a receiver. The transceiver 330 may further include one or more antennas.

In an embodiment, the communication device 300 may be a UE according to the embodiments of the present disclosure, and the communication device 300 may implement the corresponding process implemented by the UE in the method 100 according to the embodiments of the present disclosure.

FIG. 4 is a block diagram of an apparatus 400 according to embodiments of the present disclosure. The apparatus 400 includes a processor 410, which is configured to revoke and run a computer program from the memory to implement the wireless communication method 100 according to the embodiments of the present disclosure.

In an embodiment, as shown in FIG. 4, the apparatus 400 may further include a memory 420. The processor 410 may revoke and run a computer program from the memory 420 to implement the wireless communication method 100 according to the embodiments of the present disclosure.

The memory 420 may be a separate device independent of the processor 410, or may be integrated in the processor 410.

In an embodiment, the apparatus 400 may further include an input interface 430. The processor 410 may control the input interface 430 to communicate with other devices or chips, e.g., obtaining information or data sent by other devices or chips.

In an embodiment, the apparatus 400 may further include an output interface 440. The processor 410 can control the output interface 440 to communicate with other devices or chips, e.g., outputting information or data to other devices or chips.

In an embodiment, the apparatus 400 can be applied to the UE according to the embodiments of the present disclosure, and the apparatus can implement the corresponding processes implemented by the UE in the method according to the embodiments of the present disclosure.

In an embodiment, the apparatus 400 can also be a chip. For example, the apparatus 400 can be a system-level chip or a system-on-chip.

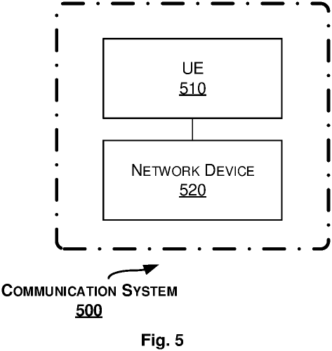

FIG. 5 is a block diagram of a communication system 500 according to embodiments of the present disclosure. As shown in FIG. 5, the communication system 500 includes a UE 510 and a network device 520. The UE 510 can be used to implement the corresponding function implemented by the UE in the above method 100. For example, the UE 510 may receive the first and second PDSCHs from the network device 520, and transmit, to the network device 520, HARQ-ACK information corresponding to the first PDSCH in the PUCCH or the PUSCH in the first slot indicated by the second DCI format, and optionally, HARQ-ACK information corresponding to the second PDSCH in the second slot, where the first slot is not later than the second slot.

It should be understood that the processor according to the embodiments of the present disclosure may be a single CPU (Central Processing Unit), but could also include two or more processing units. For example, the processor may include general purpose microprocessors; instruction set processors and/or related chips sets and/or special purpose microprocessors such as Application Specific Integrated Circuits (ASICs). The processor may also include board memory for caching purposes. The computer program may be carried by a computer program product connected to the processor. The computer program product may include a non-transitory computer readable storage medium on which the computer program is stored. For example, the computer program product may be a flash memory, a Random-Access Memory (RAM), a Read-Only Memory (ROM), or an EEPROM, and the computer program modules described above could in alternative embodiments be distributed on different computer program products in the form of memories.

The embodiments of the present disclosure also provide a computer readable storage medium having a computer program stored thereon.

In an embodiment, the computer readable storage medium can be applied to the UE according to the embodiments of the present disclosure, and the computer program causes a computer to execute the corresponding process implemented by the UE in the method according to the embodiments of the present disclosure.

The embodiments of the present disclosure also provide a computer program product including computer program instructions.

In an embodiment, the computer program product can be applied to the UE according to the embodiments of the present disclosure, and the computer program instructions cause the computer to perform the corresponding process implemented by the UE in the method according to the embodiments of the present disclosure.

The embodiment of the present disclosure also provides a computer program.

In an embodiment, the computer program can be applied to the UE according to the embodiments of the present disclosure. When executed by the computer, the computer program causes the computer to perform the corresponding process implemented by the UE in the method according to the embodiments of the present disclosure.

While the present disclosure has been described in connection with what is considered the most practical and preferred embodiments, it is understood that the present disclosure is not limited to the disclosed embodiments but is intended to cover various arrangements made without departing from the scope of the broadest interpretation of the appended claims.

1. A wireless communication method applied in a User Equipment (UE), comprising:
detecting a first Downlink Control Information (DCI) format;
receiving a first Physical Downlink Shared CHannel (PDSCH) scheduled by the first DCI format;
detecting a second DCI format, the second DCI format being detected after the first DCI format;
receiving a second PDSCH, the second PDSCH being received after the first PDSCH; and
transmitting Hybrid Automatic Repeat request-ACKnowledgement (HARQ-ACK) information corresponding to the first PDSCH in a Physical Uplink Control CHannel (PUCCH) or a Physical Uplink Shared CHannel (PUSCH) in a first slot indicated by the second DCI format.

2. The wireless communication method according to claim 1, further comprising:
transmitting HARQ-ACK information corresponding to the second PDSCH in a second slot,
wherein the first slot is not later than the second slot.

3. The wireless communication method according to claim 2, wherein the second DCI format comprises a PDSCH-to-HARQ_feedback timing indicator field providing a value indicating the first slot.

4. The wireless communication method according to claim 1, wherein the second DCI format includes a One-shot HARQ-ACK request field with a value of 1.

5. The wireless communication method according to claim 1, wherein the second DCI format comprises a PDSCH group index field indicating a same PDSCH group index as the first PDSCH.

6. The wireless communication method according to claim 1, wherein the second DCI format comprises a feedback request for both PDSCH groups corresponding to the first DCI format and the second DCI format.

7. The wireless communication method according to claim 5, wherein the UE is provided with pdsch-HARQ-ACK-Codebook=enhancedDynamic-r16.

8. The wireless communication method according to claim 1, wherein the second PDSCH is a Semi-Persistent Scheduling (SPS) PDSCH.

9. The wireless communication method according to claim 1, wherein the PUCCH or the PUSCH is assigned by the second DCI format.

10. The wireless communication method according to claim 1, wherein the second PDSCH is configured by a higher layer.

11. The wireless communication method according to claim 1, wherein the first DCI format comprises a PDSCH-to-HARQ_feedback timing indicator field providing an inapplicable value.

12. A User Equipment (UE), comprising:
a memory having computer program stored thereon; and
a processor configured to invoke and run the computer program whereby the UE is operative to:
detect a first Downlink Control Information (DCI) format;
receive a first Physical Downlink Shared CHannel (PDSCH) scheduled by the first DCI format;
detect a second DCI format, the second DCI format being detected after the first DCI format;
receive a second PDSCH, the second PDSCH being received after the first PDSCH; and
transmit Hybrid Automatic Repeat request-ACKnowledgement (HARQ-ACK) information corresponding to the first PDSCH in a Physical Uplink Control CHannel (PUCCH) or a Physical Uplink Shared CHannel (PUSCH) in a first slot indicated by the second DCI format.

13. The UE according to claim 12, wherein the UE is further operative to:
transmit HARQ-ACK information corresponding to the second PDSCH in a second slot, wherein the first slot is not later than the second slot.

14. The UE according to claim 12, wherein the second DCI format includes a One-shot HARQ-ACK request field with a value of 1.

15. The UE according to claim 12, wherein the second DCI format comprises a PDSCH group index field indicating a same PDSCH group index as the first PDSCH.

16. The UE according to claim 12, wherein the second DCI format comprises a feedback request for both PDSCH groups corresponding to the first DCI format and the second DCI format.

17. The UE according to claim 12, wherein the second PDSCH is a Semi-Persistent Scheduling (SPS) PDSCH.

18. The UE according to claim 12, wherein the PUCCH or the PUSCH is assigned by the second DCI format.

19. The UE according to claim 12, wherein the second PDSCH is configured by a higher layer.

20. The UE according to claim 12, wherein the first DCI format comprises a PDSCH-to-HARQ_feedback timing indicator field providing an inapplicable value.
